(19) United States
(12) Patent Application Publication
(10) Pub. No.: US 2024/0077752 A1
(43) Pub. Date: Mar. 7, 2024

(54) Makeup Protectors for Eyewear

(71) Applicant: Brittany Blackamore, Laguna Niguel, CA (US)

(72) Inventor: Brittany Blackamore, Laguna Niguel, CA (US)

(21) Appl. No.: 18/115,684

(22) Filed: Feb. 28, 2023

Related U.S. Application Data
(60) Provisional application No. 63/316,631, filed on Mar. 4, 2022.

(51) Int. Cl. G02C 11/02

(52) U.S. Cl. CPC G02C 11/02

(57) ABSTRACT

This invention, Makeup Protectors for Eyewear, are comprised of oil absorbing stickers with adhesive backing that adhere to eyewear to prevent said eyewear from smudging, smearing, or removing makeup on the user's nose and face, and to prevent eyewear from sliding down the user's nose. The Makeup Protectors are applied to the nose pads and frames eyewear (including, but not limited to, eyeglasses and sunglasses) with theft self-adhesive backing. Said Makeup Protectors absorb natural skin oils; this oil absorption helps to reduce nose marks, makeup smudges, and makeup removal on the user's nose; and said oil absorption also helps to reduce eyewear from slipping down the user's nose.

Independent claim 1: An adhesive, oil-absorbing sticker for eyewear, comprising: Oil-Absorbing Material with a Self-Adhesive Backing; wherein these blotting stickers, called Makeup Protectors, are applied to the nose pads and rims of Eyewear (including, but not limited to, eyeglasses and sunglasses); in which these Makeup Protectors absorb natural skin oils; said oil absorption helps to reduce nose marks, makeup smudges, and makeup removal on the user's nose; and said oil absorption also helps to reduce Eyewear from slipping down the user's nose.

Claim 2 (Dependent): The article of claim 1, Makeup Protectors are comprised of Oil-Absorbing Material (which can be composed of blotting paper, rice paper, wax paper, cotton paper, flax seed paper, silicone, sponge, foam, or similarly absorbent material) and Self-Adhesive Backing; said Makeup Protectors can also be referred to as Blotting Stickers.

Claim 3 (Dependent): The article of claim 1, Makeup Protectors absorb natural oils from a user's skin and/or makeup while wearing Eyewear; this said oil absorption reduces nose marks, makeup smudging and removal; and this said oil absorption prevents Eyewear from sliding down the user's nose.

Claim 4 (Dependent): The article of claim 1, Makeup Protectors (formed by Oil-Absorbing Material with Self-Adhesive Backing) adhere to said Eyewear on the nose pads and/or rims area of the Eyewear frames (Eyewear includes but is not limited to: eyeglasses, sunglasses, bluelight glasses, goggles, frames, and protective eyewear).

Claim 5 (Dependent): The article of claim 1, Makeup Protectors reduce smudging, smearing, and/or removing makeup from a user's nose and face as a result of wearing Eyewear for any length of time; and said Makeup Protectors prevent Eyewear from sliding down the user's nose.
What drawing figures will you include? Drawings and photographs of invention (10 pages).

What are the Parts or Components?
Component 1. Oil-Absorbing Material (which can be composed of paper, blotting paper, rice paper, wax paper, cotton paper, flax seed paper, silicone, sponge, foam, or similarly absorbent material)
Component 2. Adhesive backing to adhere to Oil-Absorbing Material 1 to Eyewear
Component 3. Makeup Protectors, also called Blotting Stickers, are formed using Component 1, Oil-Absorbing Material, and Component 2, Adhesive backing

How do the Components Connect?

The Oil-Absorbing Material 1 is manufactured with an Adhesive 2, these two form a Blotting Sticker 3, which may be covered with a protective strip or may be located on a release sheet. This Makeup Protector Blotting Sticker can then be applied to eyewear using the Adhesive 2 backing. The invention is intended to apply on the nose pads and/or inside frames of eyewear, where the eyewear comes into contact with the user's skin (e.g., nose, cheeks, or forehead).

To apply the invention to eyewear, the user would need to apply the Makeup Protector Blotting Sticker (formed with Oil-Absorbing Material and an Adhesive), with the Adhesive 2 applied directly to the eyewear that touches the user's face. This Oil-Absorbing Material will absorb natural skin oils to reduce smudging, smearing, and removing makeup on the user's skin and to reduce slipping of eyewear down a user's nose.

How does the Invention Operate?

Blotting Stickers (also called Makeup Protectors) consist of Oil-Absorbing Material 1 that is applied to the nose pads or rims of eyewear using the Adhesive Backing 2. The purpose of these Makeup Protector Blotting Stickers is to use Oil-Absorbing Material 1 to absorb natural skin oils, this oil absorption prevents eyewear from smudging, smearing, or removing makeup from the user's skin and prevents eyewear from sliding down user's nose. Oil-Absorbing Material 1 absorbs natural oils from skin and makeup, thus preserving makeup, allowing users to wear their eyewear without smudging, smearing, or removing their makeup.

Are there Other Ways to Construct Your Invention?

Blotting Stickers (also called Makeup Protectors) can be constructed with any type of Oil-Absorbing Material to any Adhesive that will adhere to eyewear. Oil-Absorbing Material 1 can be composed of blotting paper, rice paper, wax paper, cotton paper, flax seed paper, silicone, sponge, foam, or similarly absorbent material to remove oil from the skin. Adhesive 2 can be any adhesive, including but not limited to glue-based adhesives or dual-sided tape adhesives.

Can Your Invention be Used in More than One Way?

This invention can also be used to preserve makeup when wearing headwear including hats and beanies. The Makeup Protector Blotting Sticker could be applied to the inside of headwear that comes into contact with a user's skin. Headwear could include, but is not limited to, a hat, helmet, beanie, hard hat, do-rag, scarf, or bandana. This invention would prevent smudging, transferring, or removing the user's makeup onto said headwear.

### BRIEF DESCRIPTION OF DRAWINGS

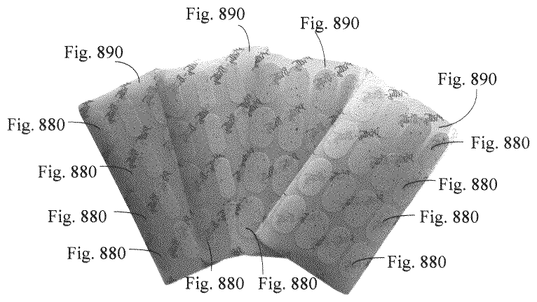

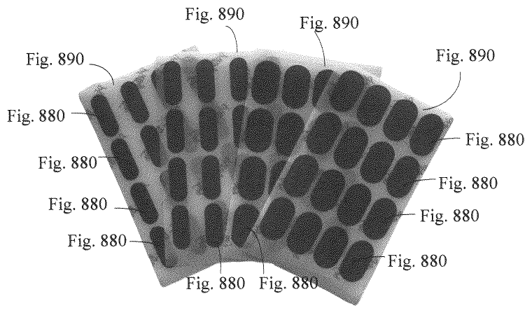

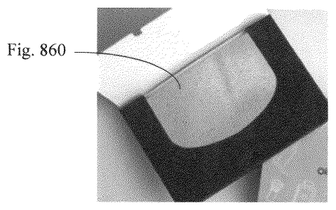

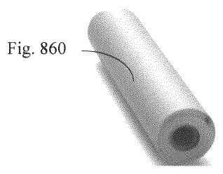

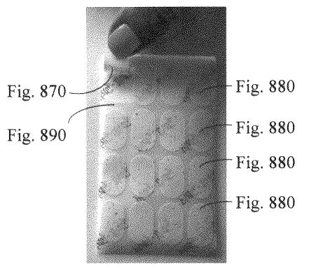

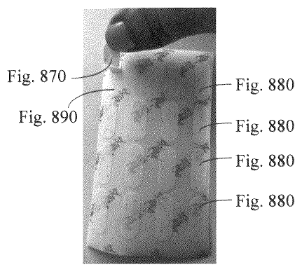

Parts/Components Identified:
1. Oil-Absorbing Material 1 (can be composed of blotting paper, wood pulp, rice paper, wax paper, cotton paper, flax seed paper, silicone, sponge, foam, or other similarly absorbent material) (FIG. 860)
2. Adhesive 2 to adhere Oil-Absorbing Material 1 to eyewear (FIG. 870)
3. Makeup Protector, also called Blotting Sticker, (formed by parts 1 and 2 above), which adheres to eyewear (FIG. 880)
4. Release Paper (FIG. 890) that protects the adhesive backing on the Makeup Protectors prior to application
5. Nose Pads of eyewear (FIG. 810)
6. Rims of eyewear (FIG. 820)

### DETAILED DESCRIPTION OF DRAWINGS

See enclosed drawings and photos of the Makeup Protectors Blotting Stickers.

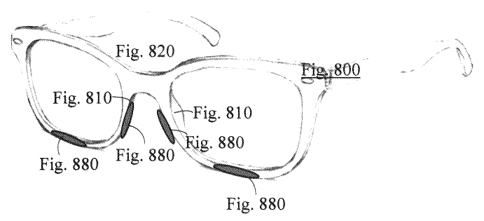

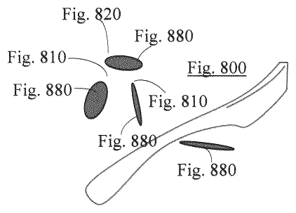

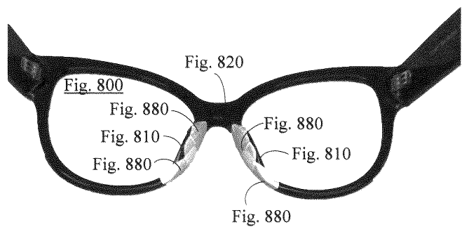

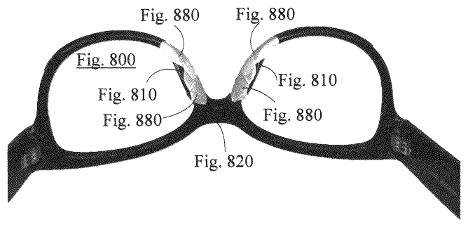

FIG. 800 represents the eyewear (e.g., sunglasses, eyeglasses, reading glasses, safety glasses, goggles, etc.)

FIG. 810 represents the nose pads of the eyewear

FIG. 820 represents the rims of the eyewear

FIG. 860 represents the Oil-Absorbing material (composed of blotting paper, wood pulp, rice paper, etc.)

FIG. 870 represents the Adhesive Backing (adhered to the back of the Makeup Protector Blotting Stickers)

FIG. 880 represents the oil-absorbing Makeup Protector Blotting Stickers with adhesive backing

FIG. 890 represents the release paper that protects the adhesive backing on the Makeup Protectors prior to application

Drawings Page 1 is an illustration of oil-absorbing Makeup Protectors with adhesive backing for the eyewear (viewed from a front side angle)

Drawings Page 2 is an illustration of the oil-absorbing Makeup Protectors with adhesive backing, attached to eyewear (viewed from a back side angle)

Drawings Page 3 is a photo of oil-absorbing Makeup Protectors with adhesive backing, applied to the nose pads and rims of sunglasses. A photo is used because the makeup protectors adhere to the eyewear and are not easily visible in black-and-white drawings. Makeup Protectors can vary in size, shape, thickness, color, and material. Two sizes are shown in this example (i.e., wider sticker on top and narrower sticker on bottom of rims).

Drawings Page 4 is an example of oil-absorbing Makeup Protectors with adhesive backing, applied to the nose pads and rims of sunglasses. A photo is used because the makeup protectors adhere to the eyewear and are not easily visible in black-and-white drawings. Makeup Protectors can vary in size, shape, thickness, color, and material. Two sizes are shown in this example (i.e., wider sticker on top and narrower sticker on bottom of rims).

Drawings Page 5 is a photo of the oil-absorbing self-adhesive Makeup Protectors (880, also called Blotting Stickers), made with pink colored blotting paper (an absorbent material). The adhesive backing is protected by the release sheet (890). A photo is used because the makeup protectors adhere to the eyewear and are not easily visible in black-and-white drawings. These stickers can vary in size, shape, thickness, color, and material. Two sizes are shown here.

Drawings Page 6 is an example of the oil-absorbing self-adhesive Makeup Protectors (880, also called Blotting Stickers), made with black colored blotting paper (an absorbent material). A photo is used because the makeup protectors adhere to the eyewear and are not easily visible in black-and-white drawings. The adhesive backing is protected by the release sheet (890). These stickers can vary in size, shape, thickness, color, and material. Two sizes are shown here.

Drawings Page 7: Example of Blotting Paper, an Oil-Absorbing material Drawings Page 8: Example of Blotting Paper, an Oil-Absorbing material Drawings Page 9: Example of Adhesive Backing, which is applied to the back of the Oil-Absorbing material. Combined together, the Oil-Absorbing Material and Adhesive Backing form Makeup Protectors.

Drawings Page 10: Example of Adhesive Backing, which is applied to the back of the Oil-Absorbing material. Combined together, the Oil-Absorbing Material and Adhesive Backing form Makeup Protectors.

### Idea Origination:

Sunglasses always ruin the makeup on my nose and that of my friends, so I looked for a solution for years. When I discovered how well blotting paper and toilet seat covers (a free solution similar to blotting paper) removed oil from my face, I realized that a blotting paper between my glasses and my nose could absorb natural skin oils and keep my makeup on my nose, where it belongs.

I began testing the product by first using wax paper, then a toilet seat cover, then various types of blotting paper along with double-sided tape to adhere the solution to my glasses. I also tested with silicone-based foam with double-sided tape. In every trial, my makeup remained on my nose when I used the solution, which I coined as “Makeup Protectors” or “Blotting Stickers”.

I started to test solutions with one side of the glasses uncovered and one side with my Makeup Protector solution. In every trial, my makeup would be untouched where I used the Makeup Protectors, while my makeup would be smudged and removed on the side where I did not add a Makeup Protector.

After successful trials using my own materials, I looked for die-cut manufacturers to create Makeup Protector Blotting Stickers with an adhesive backing to create my prototypes. We made several iterations with various oil-absorbing materials and different sizes, which I tested successfully. This is the only solution of its kind to prevent eyewear from smudging, smearing, and removing makeup from a user's nose and face.

I also discovered an additional benefit to Makeup Protectors. Because the blotting paper absorbs natural oils in your skin, the makeup protectors prevent glasses from sliding down your nose as well.

1. An adhesive, oil-absorbing sticker for eyewear, comprising: Oil-Absorbing Material with a Self-Adhesive Backing; wherein these blotting stickers, called Makeup Protectors, are applied to the nose pads and rims of Eyewear (including, but not limited to, eyeglasses and sunglasses); in which these Makeup Protectors absorb natural skin oils; said oil absorption helps to reduce nose marks, makeup smudges, and makeup removal on the user's nose; and said oil absorption also helps to reduce Eyewear from slipping down the user's nose.

2. The article of claim 1, Makeup Protectors are comprised of Oil-Absorbing Material (which can be composed of blotting paper, rice paper, wax paper, cotton paper, flax seed paper, silicone, sponge, foam, or similarly absorbent material) and Self-Adhesive Backing; said Makeup Protectors can also be referred to as Blotting Stickers.

3. The article of claim 1, Makeup Protectors absorb natural oils from a user's skin and/or makeup while wearing Eyewear; this said oil absorption reduces nose marks, makeup smudging and removal; and this said oil absorption prevents Eyewear from sliding down the user's nose.

4. The article of claim 1, Makeup Protectors (formed by Oil-Absorbing Material with Self-Adhesive Backing) adhere to said Eyewear on the nose pads and/or rims area of the Eyewear frames (Eyewear includes but is not limited to: eyeglasses, sunglasses, bluelight glasses, goggles, frames, and protective eyewear).

5. The article of claim 1, Makeup Protectors reduce smudging, smearing, and/or removing makeup from a user's nose and face as a result of wearing Eyewear for any length of time; and said Makeup Protectors prevent Eyewear from sliding down the user's nose.
What drawing figures will you include? Drawings and photographs of invention (10 pages).
What are the parts or components?
Component 1. Oil-Absorbing Material (which can be composed of paper, blotting paper, rice paper, wax paper, cotton paper, flax seed paper, silicone, sponge, foam, or similarly absorbent material)
Component 2. Adhesive backing to adhere to Oil-Absorbing Material 1 to Eyewear
Component 3. Makeup Protectors, also called Blotting Stickers, are formed using Component 1, Oil-Absorbing Material, and Component 2, Adhesive backing
How do the components connect?
